(19) United States
(12) Patent Application Publication
(10) Pub. No.: US 2008/0257713 A1
(43) Pub. Date: Oct. 23, 2008

(54) CATALYTIC REACTORS WITH ACTIVE BOUNDARY LAYER CONTROL

(76) Inventor: Robert Woodhull Grant, Camden, ME (US)

Correspondence Address: ELMORE PATENT LAW GROUP, PC, 515 Groton Road, Unit 1R, Westford, MA, 01886, US

(21) Appl. No.: 12/101,276

(22) Filed: Apr. 11, 2008

Related U.S. Application Data
(60) Provisional application No. 60/923,818, filed on Apr. 17, 2007.
(60) Provisional application No. 60/992,934, filed on Dec. 6, 2007.

(51) Int. Cl. B01J 19/10; B01J 19/00; B01J 19/12

(52) U.S. Cl. 204/157.15; 422/222

(57) ABSTRACT

The present invention provides efficient catalytic reactors with active boundary layers in a presence of at least one mechanical disturbance and methods of improving the efficiency of the catalytic reaction with the use of at least one mechanical disturbance. The presence of at least one mechanical disturbance would improve the surface contact at the catalytic site and thereby increase the overall efficiency of the catalytic reactors. Such an improvement would require less catalyst material and shorter channels used, thereby decreasing the size of the catalytic reactors.

### RELATED APPLICATIONS

This application claims the benefit of U.S. Provisional Application No. 60/923,818, filed on Apr. 17, 2007 and U.S. Provisional Application No. 60/992,934, filed on Dec. 6, 2007. The entire teachings of the above applications are incorporated herein by reference.

### TECHNICAL FIELD

The present invention relates to efficient catalytic reactors with active boundary layers in the presence of at least one mechanical disturbance, as well as methods of improving the efficiency of the catalytic reaction with at least one mechanical disturbance. The present invention is useful in catalytic synthesis, cracking or recombining gases or fluids.

### BACKGROUND OF THE INVENTION

Many catalytic reactors are known to use laminar flow path to introduce the gases or fluids into a reactor. While the gases and fluids closest to the catalytic site can make contact with the catalytic surface, a majority of the gases or fluids would pass through the reactor without making such contact or would require much longer time to make contact with the catalysts and thus the overall efficiency of the reaction is less than optimal. Recent advances have been made to improve the reaction rate by increasing the surface area of the catalytic site with the use microchannels inside a reactor. In addition, various efforts have been made to increase the reaction rates by using various reactor shapes, flow paths, temperatures, or combinations thereof, in order to improve efficiency. However, such laminar flow path is still inefficient in delivering the gases or fluids to the catalytic site. The present invention provides efficient catalytic reactors with active boundary layers in the presence of at least one mechanical disturbance and methods of improving the efficiency of the catalytic reaction with the use of at least one mechanical disturbance. The presence of at least one mechanical disturbance would improve the surface contact and thereby increase the overall efficiency of the catalytic reactors. Such an improvement would require less catalyst material and shorter channels, thereby decreasing the overall size of the catalytic reactors.

### SUMMARY OF THE INVENTION

The present invention provides catalytic reactors comprising at least one flow channel wherein the internal surfaces are plated or coated with at least one catalyst and at least one mechanical disturbance is applied to the body of the reactor causing the channel walls to move or vibrate accordingly or propagated into or through the flowing gas or fluid. The invention further provides methods of enhancing the efficiency of the catalytic reactors by introducing at least one mechanical disturbance into the catalytic reactors containing at least one flow channel wherein the internal channel surfaces are plated or coated with a catalyst. The mechanical disturbance reduces the boundary layer within the channel(s), thereby increases the speed at which the flowing gases and/or fluids make contact with the walls of the channel(s). The boundary layer is the layer in which the gas velocity is flowing less than 10% of the free flowing gas in the center of the channel which is reduced in direct proportion to the disturbance frequency by creating flow loops or couplets as shown in FIG. 1. In the normal case, without periodic disturbance, gas velocities approach “0” near the surface. This layer can be quite thick, relying on gas diffusion to bring the gas to the catalytic surface. To overcome this phenomenon, frequencies as high as the kilohertz range are used. In one example, an acoustic disturbance (sound) can be applied to the flowing gas itself to achieve a reduced boundary layer.

### BRIEF DESCRIPTION OF THE FIGURES

FIG. 1 is an illustration of a gas 2 flowing through a channel having a surface 3, thereby forming a boundary layer 3.

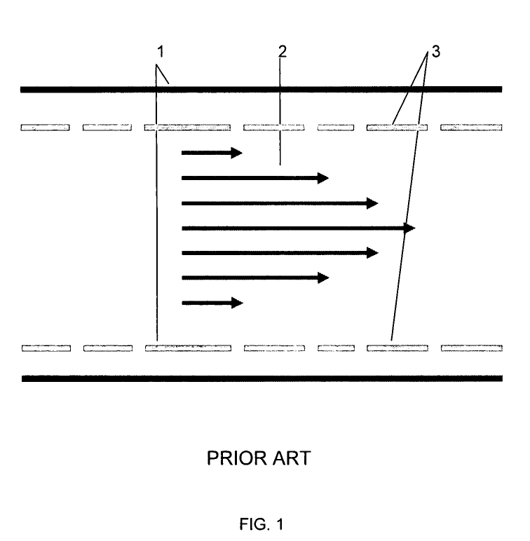

FIG. 2A is an illustration of a catalytic device of the invention whereas FIG. 2B is an expanded view of the gas flow couplets within a microchannel.

### DETAILED DESCRIPTION OF THE PRESENT INVENTION

Catalysts are used throughout the world to facilitate chemical reactions. For example, platinum based catalytic converters used in automobiles purify exhaust gases. Large “bricks” of ceramic material are cast with many long holes or channels that allow the exhaust gas to flow through contact the catalyst. If the gas could be reacted in a shorter length, huge cost savings could be achieved by way of reduced ceramic substrate and precious metal cost. In one embodiment, the present invention provides catalytic reactors comprising at least one flow channel wherein the internal surfaces are comprised of, plated with or coated with a catalyst and at least one mechanical disturbance is applied to the body of the reactor causing the channel walls to move or vibrate accordingly or propagated into or through the flowing gas or fluid.

The use of catalytic material supported on a metal substrate is well known. For example GB 1 490 977 describes a catalyst comprising an aluminum-bearing ferritic alloy substrate, coated with a layer of a refractory oxide such as alumina, titania or zirconia, and then with a catalytic platinum-group metal. As described in GB 1 531 134 and GB 1 546 097, a catalyst body may comprise substantially flat sheets and corrugated sheets of such material arranged alternately so as to define channels through the body, either several such sheets arranged in a stack, or two such sheets wound together to form a coil. In these examples both the flat sheets and the corrugated sheets have small-scale corrugations superimposed upon them to help in the formation of the coating. Such catalyst bodies are described as being suitable for use in treating exhaust gas from vehicles. In this context heat transfer between one channel and an adjacent channel is not a substantial consideration, as all the channels carry the same gases at the same temperature and pressures. EP 0 885 653 A (Friedrich et al.) describes a compact heat exchanger for catalytic reactions in which flow channels are defined by a single long sheet of metal folded into a concertina, with corrugated foils located between successive plates of the concertina; the corrugated foils are catalyst supports and enhance heat transfer between the channels, and in one example the gases on one side of the sheet undergo an exothermic reaction while those on the other side undergo an endothermic reaction.

In one embodiment, ceramic coatings may be deposited from a material in the form of a sol, that is to say a dispersion containing particles with a particle size between 1 nm and 1 μm. For a particular sol, such as alumina sol, the way in which the sol is prepared determines the particle size. Some alumina sols have individual particles as the primary sol particles (so-called unaggregated), whereas some alumina sols have sol particles that are aggregates of smaller particles. In general, the aggregated type of sol will give a more porous ceramic coating than an unaggregated sol. Thus by selecting the type of sol used, or by mixing various amounts of different types of sol, the porosity of the ceramic coating can be controlled. The catalytic activity of the ceramic coating can be controlled by adjusting the porosity of the ceramic, the loading of the catalytic material and mechanical disturbance. When making a catalytic reactor for performing a very exothermic reaction it may be desirable to adjust the catalytic activity along the flow path, for example to provide low catalytic activity initially, and higher catalytic activity further along the flow path in the presence of at least one mechanical disturbance, so as to prevent formation of hot spots. This may, for example, be appropriate in the case of reactors for performing Fischer-Tropsch synthesis. When using a zirconia sol to form a zirconia ceramic coating similar considerations apply; and in addition it may be desirable to include cations such as yttrium so as to form stabilized zirconia, particularly where the ceramic coating may reach high temperatures during operation, as stabilised zirconia provides a stable surface area.

In one embodiment the catalyst may comprise a Fischer-Tropsch catalyst, such as a catalyst that comprises at least one catalytically active metal or oxide thereof. In one embodiment, the catalyst further comprises a catalyst support. In one embodiment, the catalyst further comprises at least one promoter.

The catalytically active metal may comprise, for example, Co, Fe, Ni, Ru, Re, Os, Rh or a combination of two or more thereof. The support material may comprise, for example, alumina, zirconia, silica, aluminum fluoride, fluorided alumina, bentonite, ceria, zinc oxide, silica-alumina, silicon carbide, a molecular sieve, or a combination of two or more thereof. The support material may comprise a refractory oxide.

Catalytic promoters (for Fischer-Tropsch or other reactions) may comprise a Group IA, IIA, IIIB or IVB metal or oxide thereof, a lanthanide metal or metal oxide, or an actinide metal or metal oxide. In one embodiment, the promoter is Li, B, Na, K, Rb, Cs, Mg, Ca, Sr, Ba, Sc, Y, La, Ac, Ti, Zr, La, Ac, Ce or Th, or an oxide thereof, or a mixture of two or more thereof.

Examples of catalysts that may be used include those disclosed in U.S. Pat. Nos. 4,585,798; 5,036,032; 5,733,839; 6,075,062; 6,136,868; 6,262,131B1; 6,353,035B2; 6,368,997B2; 6,476,085B2; 6,451,864B1; 6,490,880B1; 6,537,945B2; 6,558,634B1; and U.S. Patent Publications 2002/0028853A1; 2002/0188031A1; and 2003/0105171A1; these patents and patent publications being incorporated herein by reference for their disclosures of catalysts and methods for preparing such catalysts. In one non-limiting embodiment, the catalytic reactor is a catalytic converter.

Catalytic converters can also have a variety of configurations. Exemplary configurations include substrates defining channels that extend completely therethrough. Exemplary catalytic converter configurations having both corrugated metal and porous ceramic substrates/cores are described in U.S. Pat. No. 5,355,973, that is hereby incorporated by reference in its entirety. The substrates preferably include a catalyst. For example, the substrate can be made of a catalyst, impregnated with a catalyst or coated with a catalyst. Exemplary catalysts include precious metals such as platinum, palladium and rhodium, and other types of components such as base metals or zeolites.

In one example, a catalytic converter or reactor can have a cell density of at least 200 cells per square inch, or in the range of 200-400 cells per square inch. A preferred catalyst for a catalytic converter is platinum with a loading level greater than 30 grams/cubic foot of substrate. In other embodiments, the precious metal loading level is in the range of 30-100 grams/cubic foot of substrate. In certain embodiments, the catalytic converter can be sized such that in use, the catalytic converter has a space velocity (volumetric flow rate through the DOC/volume of DOC) less than 150,000/hour or in the range of 50,000-150,000/hour.

The catalytic reactor may be constituted by a plurality of layers, and in this case, it is possible to contain the different kinds of oxide contained and/or catalytic active constituent supported in layer by layer. For example, CeO₂ having functions of storage and discharge oxygen contributes improvement of three-way performance, therefore CeO₂ is possible to use as the oxide constituting the catalyst coating layer. Rh accelerates NOx decomposition reaction and NOx reduction reaction, therefore Rh is a useful precious metal, but Rh easily reacts with CeO₂ to form a solid solution which causes of the catalytic inactivity. Therefore, it is preferable to use both materials in different layers in separation. Furthermore, Pt has a function which improves the light-off performance, so in one preferable embodiment, Pt is to be supported in a layer which easily contacts with the exhaust gas and the other precious metals are supported in the other layers.

In one embodiment, the catalyst layers comprise fluid-permeable metal heat transfer layers with a catalyst coating. Similar metal heat-transfer layers are preferably also provided in the first gas flow channels, although in this case the gas flow direction is straight through the channel. This improves heat transfer. In each case the metal heat-transfer layer may comprise a non-planar metallic foil, or a metallic foam, mesh, fiber mat, honeycomb, or a similar structure combining ceramic and metal, for example; it must be highly permeable to the flow in the desired direction. Typically a corrugated foil is suitable.

Preferably the sheets are flat, with grooves machined or etched across their surfaces to define the flow channels. The reactor might therefore comprise a stack of such flat plates sufficiently thick to withstand the necessary pressure difference, the grooves in adjacent plates following different paths. The grooves may be for example 20 mm wide, this width being determined by the pressure difference to which the sheet is exposed, each accommodating one or more corrugated foil of material coated with catalytic material. Bonding the plates together, for example by diffusion bonding, ensures that the flow channels are gas tight.

In one preferred embodiment the flow channels consist of microchannels. The term “microchannels” refers to a channel having at least one internal dimension of height or width of up to about 10 millimeters (mm), and in one embodiment up to about 5 mm, and in one embodiment up to about 2 mm, and in one embodiment up to about 1 mm. In one embodiment, channels have at least one internal dimension of height or width of at least 0.1 μm, most preferably at least 0.5 μm. In one embodiment, the height or width is in the range of about 0.5 μm to about 10 mm, and in one embodiment about 0.5 μm to about 5 mm, and in one embodiment about 0.5 μm to about 2 mm, and in one embodiment about 0.5 μm to about 1.5 mm, and in one embodiment about 0.5 μm to about 1 mm, and in one embodiment about 0.5 μm to about 0.75 mm, and in one embodiment about 0.5 μm to about 0.5 mm. Both height and width are perpendicular to the direction of flow through the microchannel.

In one embodiment, the microchannels are prepared by anisotropic etching methodology. Anisotropic etching has been used to etch microchannels in silicon wafers for several years. Anisotropic etching of silicon takes advantage of the fact that some chemicals (most commonly potassium hydroxide) etch crystal planes of different orientation at different rates. The ratio of the etch rates for the (110) to the (111) planes can be as high as 600:1. In <110> oriented wafers (the surface of the wafer is a (110) plane) the difference in etch rates can be exploited to etch channels that are perpendicular to the surface of the wafer. This is accomplished by creating a mask on the surface of the wafer that is aligned with the (111) planes in the wafer. When etched, these slow etching, perpendicular (111) planes then become the walls of the channels. Because these masks can be made photolithographically, the feature sizes created by this process can be very small and their resolution and accuracy tightly controlled.

The term “anisotropic etching” refers to etching which does not proceed in all directions at the same rate. If etching proceeds exclusively in one direction (e.g. only vertically), the etching process is said to be completely anisotropic.

Removal of a header exposes the open ends of the corresponding flow channels, so each catalyst layer can be removed simply by sliding it out of the flow channel through the open end.

The fluids in the channels may be gases or gas mixtures, and may also comprise droplets of liquid as an aerosol. Where a desired reaction between gases in the second flow channels is exothermic, a heat transfer liquid (rather than a gas) may be passed through the first flow channels.

In one use of the catalytic reactor, the gas mixture supplied to each channel is different from the gas mixture supplied to the adjacent channels, and the corresponding chemical reactions are also different. One of the reactions may be endothermic while the other reaction is exothermic. In that case heat is transferred through the wall of the sheet separating the adjacent channels, from the exothermic reaction to the endothermic reaction.

This reactor is particularly suitable for performing steam reforming of a hydrocarbon (which is an endothermic reaction, generating hydrogen and carbon monoxide), and the alternate channels might contain a methane/air mixture so that the exothermic oxidation reaction provides the necessary heat for the endothermic reforming reaction. For the oxidation reaction several different catalysts may be used, for example palladium, platinum or copper on a ceramic support; for example copper or platinum on an alumina support stabilised with lanthanum, cerium or barium, or palladium on zirconia, palladium on a metal hexaaluminate such as magnesium, calcium, strontium, barium or potassium hexaaluminate. For the reforming reaction also several different catalysts may be used, for example nickel, platinum, palladium, ruthenium or rhodium, which may be used on ceramic coatings; the preferred catalyst for the reforming reaction is rhodium or platinum on alumina or stabilised alumina. The oxidation reaction may be carried out at substantially atmospheric pressure, while the reforming reaction may be carried out at elevated pressure, for example up to 2 MPa (20 atmospheres), more typically in the range 0 to 200 kPa above atmospheric pressure.

It will be appreciated that the materials of which the reactor are made may be subjected to a severely corrosive atmosphere in use, for example the temperature may be as high as 900° C., and typically around 850° C. The reactor may be made of a metal such as an aluminum-bearing ferritic steel, in particular of the type known as Fecralloy™ which is iron with up to 20% chromium, 0.5-12% aluminum, and 0.1-3% yttrium. For example it might comprise iron with 15% chromium, 4% aluminum, and 0.3% yttrium. When this metal is heated in air it forms an adherent oxide coating of alumina which protects the alloy against further oxidation; this oxide layer also protects the alloy against corrosion under conditions that prevail within for example a methane oxidation reactor or a steam/methane reforming reactor. Where this metal is used as a catalyst substrate, and is coated with a ceramic layer into which a catalyst material is incorporated, the alumina oxide layer on the metal is believed to bind with the ceramic coating, so ensuring the catalytic material adheres to the metal substrate.

A problem with any catalytic reactor is that the catalyst may become less active, and hence need to be replaced. Since the reactors are designed to be suitable for use at high temperatures and pressures the plates are desirably bonded together by a process such as diffusion bonding (which ensures gas-tight sealing), but it would be desirable to be able to reuse the bulk of the structure while being able to replace the catalysts. Furthermore co-current or counter-current flow of the two gas streams is desirable, rather than transverse flow, to achieve a satisfactory temperature distribution; the gas-permeable catalyst structures in the second flow channels achieve this.

For some purposes the catalyst metal might instead be deposited directly onto the adherent oxide coating of the metal (without any ceramic layer).

Especially if the reactor is to be used for an endothermic reaction, it may be desirable to raise the temperature of the reactor to a desired operating temperature by direct electrical heating, passing electric current through the sheets that form the reactor. This would typically only be done initially, the heat subsequently being provided by an exothermic reaction carried out in the second gas flow channels or by hot gases (for example exhaust gases from an external combustion process such as a laminar flow burner).

In one embodiment, the invention further provides methods of enhancing the efficiency of the catalytic reactors by introducing at least one mechanical disturbance into the catalytic reactors containing at least one flow channel wherein the internal channel surfaces are plated or coated with a catalyst.

The mechanical disturbance of the invention includes, but is not limited to, acoustic disturbance (sound) or a mechanical actuator such as a piezoelectric or electromagnetic transducer. In one example, the disturbance is a sound wave, wherein the sound wave can be optionally amplified.

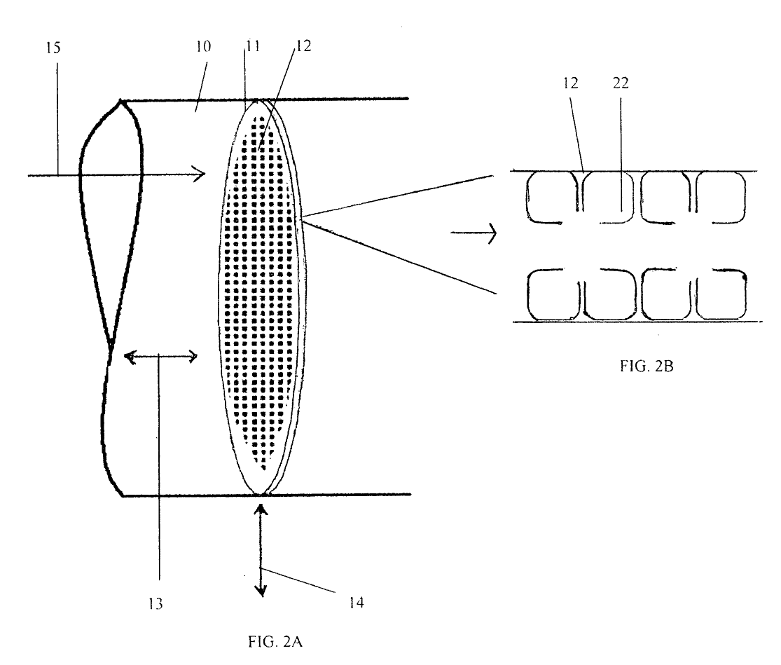

Referring to FIG. 2A, a device of the invention is shown. The figure illustrates a reactor 10, which can be a flow pipe or other containment, having disposed therein a substrate body 11 and catalyst coated channels 12 disposed within the substrate body. Fluid flow 15 is directed along the flow pipe and channels. Periodic disturbances, such as those produced acoustically, can be introduced perpendicularly 14 or in parallel 13 to the direction of the fluid flow. FIG. 2A provides an expanded view of a channel 12 and shows the gas flow couplets 22 that are achieved along the boundary layer.

An acoustic boundary layer has a thickness proportional to the square root of viscosity divided by frequency of the disturbance in the flowing medium. This boundary layer is composed of counter rotating flow couplets. In order to fully “stir” or mix, thereby bringing all of the gas or fluid to the surface, the ideal dimension of the flowing channel or tube is about two times the dimension of the acoustic boundary layer. Alternatively, the ideal acoustic frequency is designed to provide an acoustic boundary layer that is about half the channel dimension, for a specific fluid viscosity. In this case, virtually all of the fluid can be caused to visit the proximity of the catalytic surface (there is a minimal amount of fluid in the flow channel that is not affected). In the FIG. 2B, the flow couplets are shown on opposing walls of a flow channel. In the case of CO₂ gas at 60 bar, for example, the acoustic boundary layer is a hundred times smaller that the normal fluid boundary layer and is about 10 microns in size for about one megahertz. Therefore the flow channel is best built in the 15 to 30 micron size for this frequency and condition.

If the disturbance is generated through the walls of the flow channel, the speed of sound, density etc. may be different than that of the fluid being reacted. Also the resonant frequency and/or acoustic impedance of the flow channel itself and/or the transducer creating the energy may be different and a sub-resonant frequency may need to be selected. That is, single pulses and/or a series of pulses can be used to create what will become the correct frequency of use in the flowing fluid and channel dimension. In order to transmit the acoustic energy into the solid material comprising the flow channel(s), an acoustic matching layer can be implemented. Acoustic matching layers are known in the art, and are used in sonogram instruments and the like. In the present case, a matching layer can be used to transmit sound into a very dense material such as ceramic or metal that comprises the flow catalyst device. Matching layer(s) comprise layer(s) of material with varying speeds of sound and density selected to achieve characteristics that “match” the acoustic impedence of the targeted material. A matching layer will prevent or decrease the reflection of energy as sound is transmitted from one medium/surface to or through another. Generally, each layer of several can match to about 10 percent with the subsequent layers doing their part util the total effect is up to 90% efficient. This way, a high percentage of the energy can be transmitted with little loss. Since these channels are fairly small, one can see why microchannels as stated are favored for best case performance.

A transducer, for example, a piezoelectric transducer, an antiferroelectric transducer, an electrostrictive transducer, a piezomagnetic transducer, a magnetostrictive transducer, or a magnetic shape memory transducer, can be used to convert energy in form of, for example, a mechanical disturbance, to electrical energy. Examples of sources of mechanical energy include: environmental sources such as wind, ocean waves, and earth motion; vibrating machinery such as rotating machinery, compressors, gears, and bearings; human motion such as walking, running, climbing, and hand gestures; human input such as by winding-up a device or shaking a device; vehicle motion such as automobile motion, aircraft motion, and satellite motion; movement of civil structures such as bridges and buildings; acoustic sources such as noise and speech; and impact on or motion of sports equipment.

The mechanical disturbance of the present invention can be applied continuously or periodically. The mechanical disturbance can be applied at any angle. Preferably, the mechanical disturbance can be applied perpendicularly, longitudinally, or combination thereof.

In one embodiment, the disturbance is propagated into or through the flowing gas or fluid. In one embodiment, the wavelength (λ) of the disturbance used is directly proportional to the size of the flow channel. For example, for a channel size of about 1 mm, an acoustic wavelength of about 1 mm is used. In one embodiment the frequency of the disturbance can be up in the kilohertz (KHz) range (e.g., one or more kHz) or megahertz (MHz) range (e.g., one or more MHz). The term “acoustic” denotes both audible and ultrasonic sound waves, for example up to a frequency of 10 MHz.

As illustrated in FIG. 2A, very small channels would be produced in large numbers, increasing the surface area but, more importantly, reducing the cross sectional area. The smaller area would bring the gases closer to the catalyst surface on the walls of the channels. A mechanical disturbance would then be introduced to modify the boundary layer over the catalytic surface. Gas velocities decay toward zero toward the channel wall. Only relatively slow gas diffusion will penetrate this “boundary layer.” In the upper right, the boundary layer is reduced by the mechanical disturbance, facilitating the contact of all the gas to the catalytic surface. The boundary layer thickness is reduced by as much as 100 times and is related to the inverse of the frequency. The mechanical disturbance could be sound energy from the engine, or the sound from a “speaker” or “whistle”. The overall size of the catalytic converter will be a fraction of the prior art size, and be less expensive by virtue of reduced catalyst and ceramic consumption. A periodic disturbance, sound, is propagated through the fluid or gas (mode B) and direction of propagation is not important to a reasonable degree. A more effective periodic disturbance can be achieved by directly coupling the device body to a mechanical actuator (mode A) such as a transducer, or a source of amplified sound energy from without the system. Depending on the size of the flow channels, frequencies can be selected which optimize catalytic performance of the channels or substrate. As channels are selected that are smaller in diameter than is possible to plate with usual methods (electroplating etc.), the catalyst may be plated using supercritical gas and a precursor of the catalyst. Since deposition by supercritical gas can penetrate channels of micron size of high aspect ratio, the performance of the catalytic device can be optimized without regard for traditional plating limitations.

In one embodiment, the catalyst can be plated by exposing a surface of flow channels to a supercritical fluid. As is known to persons of ordinary skill in the art, a supercritical fluid is defined as any substance that is above its critical temperature (T_{c}) and critical pressure (P_{c}). T_{c} is the highest temperature at which a gas can be converted to a liquid by an increase in pressure, and P_{c} is the highest pressure at which a liquid can be converted to a traditional gas by an increase in the liquid temperature. In the so-called critical region there is only one phase, and it possesses properties of both gas and liquid. Supercritical fluids differ from traditional liquids in several aspects. For example, the solvent power of a supercritical fluid will typically increase with density at a given temperature. The utilization of supercritical fluid can reduce a temperature at which metals are deposited relative to other methods, and yet can enhance a deposition rate of the metals. Additionally, deposition from within a supercritical fluid can allow for infiltration of very small, high aspect ratio features. This may be due to negligible surface tension during deposition and very high diffusivity. Due to its ability to fill high aspect ratio features, deposition from within a supercritical fluid can be used to fill sub-micron nano-features.

The supercritical fluid can, in particular aspects of the invention, comprise, consist essentially of, or consist of one or more of CO₂, ammonia, and an alkanol having from one to five carbon atoms. Exemplary alkanols are ethanol and methanol.

Other exemplary materials that can be formed into supercritical fluids are isooctane, hexane, heptane, butane, methane, ethane, propane, ethene, propene, water, xenon, nitrous oxide, tetrafluoromethane, difluoromethane, tetrafluoroethane, pentafluoroethane, sulfur hexafluoride, CFC-12, HCFC-22, HCFC-123, HFC-116, HFC-134a, and dimethylether.

In exemplary applications in which the supercritical fluid comprises CO₂, the chemical group utilized to enhance solubility of a metal within the fluid can comprise a fluorocarbon, with an exemplary group being hexafluoroacetylacetone. Accordingly, an exemplary copper-containing precursor is copper(II) hexafluoroacetylacetonate (Cu(hfa)₂). Additionally, or alternatively, the metal-containing precursor can comprise one or more of cobalt(II) hexafluoroacetylacetonate, nickel(II) hexafluoroacetylacetonate, and gold(II) hexafluoroacetylacetonate.

The catalyst can be provided within the supercritical fluid in combination with a group which enhances solubility of the catalyst in the supercritical fluid. For example, the catalyst can be provided in combination with the hexafluoroacetylacetone group. In an exemplary application, palladium can be provided as palladium(II) hexafluoroacetylacetonate. A possible mechanism by which the palladium can enhance deposition of copper, or other metals, is as follows. The palladium ion can be reduced to metal palladium by hydrogen. Elemental palladium from this reaction can deposit on a surface and subsequently catalyze a surface reaction in which Cu and/or other metals substitute for Pd at the surface. Additionally, or alternatively, Pd may function as a “seed” layer for subsequent deposition of Cu and/or other metals. The mechanisms are provided to assist the reader in understanding the invention. The invention is not limited to any particular mechanisms provided herein, except to the extent, if any, that particular mechanisms are recited in the claims which follow.

Although the invention has been described with respect to various preferred embodiments, it is not intended to be limited thereto, but rather those skilled in the art will recognize that variations and modifications may be made therein which are within the spirit of the invention and the scope of the appended claims.

All references cited herein, whether in print, electronic, computer readable storage media or other form, are expressly incorporated by reference in their entirety, including but not limited to, abstracts, articles, journals, publications, texts, treatises, internet web sites, databases, patents, and patent publications.

What is claimed is:

1. A catalytic device comprised of a body with at least one flow channel wherein the internal surfaces are plated or coated with at least one catalyst and at least one mechanical disturbance is applied to the body of the reactor or propagated into or through the flowing gas or fluid.

2. A catalytic device according to claim 1 wherein the disturbance reduces the thickness of the boundary layer thereby improving efficiency.

3. A catalytic device according to claim 1 wherein the disturbance is an acoustic disturbance or from a mechanical actuator.

4. A catalytic device according to claim 3 wherein the disturbance is from an amplified sound source.

5. A catalytic device according to 3 where the periodic disturbance is from a mechanical actuator such as a piezoelectric or electromagnetic transducer.

6. A catalytic device according to claim 1 wherein the disturbance can be amplified in a perpendicular or longitudinal mode.

7. A catalytic device according to claim 1 wherein the catalyst is selected from the group consisting of Pd, Pt, Ag, Au, Co, Fe, Ni, Ru, Re, Os, Rh or a combination of two or more thereof.

8. A device according to claim 1 wherein the channels are microchannels.

9. A device according to claim 8, wherein the microchannels are prepared by anisotropic etching methodology.

10. A device according to claim 1 wherein the channels are coated with catalyst and/or an adhesion layer with supercritical CO₂ methodology.

11. A method of enhancing the efficiency of the catalytic reactors by introducing the at least one mechanical disturbance into the catalytic reactors containing at least one flow channel wherein the internal channel surfaces are plated or coated with a catalyst.

12. The method according to claim 9 wherein the periodic disturbance reduces the thickness of the boundary layer thereby improving efficiency.

13. The method according to claim 9 wherein the disturbance is an acoustic disturbance or from a mechanical actuator.

14. The method according to claim 11 wherein the disturbance is from an amplified sound source.

15. The method according to claim 11 where the periodic disturbance is from a mechanical actuator such as a piezoelectric or electromagnetic transducer.

16. The method according to claim 9 wherein the disturbance can be amplied in a perpendicular or longitudinal mode.

17. The method according to claim 9 wherein the catalyst is selected from the group consisting of Pd, Pt, Ag, Au, Co, Fe, Ni, Ru, Re, Os, Rh or a combination of two or more thereof.

18. The method according to claim 9 wherein the channels are microchannels.

19. The method according to claim 18, wherein the microchannels are prepared by anisotropic etching methodology.

20. The method according to claim 9 wherein the channels are coated with catalyst and/or an adhesion layer with supercritical CO₂ methodology.
